(19) United States
(12) Patent Application Publication
(10) Pub. No.: US 2003/0041448 A1
(43) Pub. Date: Mar. 6, 2003

(54) Device for supporting flat products

(76) Inventor: Johannes Albertus Maria Van Deursen, Veldhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 10/196,100

(22) Filed: Jul. 16, 2002

(30) Foreign Application Priority Data
Jul. 19, 2001 (EP) 01202768.6

(51) Int. Cl. B23P 19/00

(52) U.S. Cl. 29/760; 29/729

(57) ABSTRACT

The invention relates to a device for supporting flat products, especially printed circuit boards. The device comprises a supporting member (4) and supporting pins (1) which can be placed on and removed from the supporting member. Recesses (5) and protrusions (3) fitting in said recesses are provided for positioning of the supporting pins in relation to the supporting member. Said recesses (5) and protrusions (3) have a non-circular cross-section. A combination of a protrusion (3) and a recess (5) positioning a supporting pin (1) in a particular position on the supporting member (4) is located eccentrically in relation to the centreline of said supporting pin (1).

The invention relates to a device for supporting flat products, especially printed circuit boards, provided with a supporting member as well as supporting pins, which can be placed on and removed from the supporting member, wherein recesses and protrusions fitting in these recesses are provided for positioning the supporting pins in relation to the supporting member.

Such devices are known, for example, from U.S. Pat. Nos. 5,218,753 and 5,794,329. In these known devices the protrusions are provided at the ends of the supporting pins such that the centrelines of the protrusions are in line with the centrelines of the supporting pins. The end of a protrusion can be inserted at choice in one of the recesses provided in the supporting member, the shape of these recesses being complementary to that of the protrusion. A supporting pin projecting above the supporting member is always in line with the centreline of the hole provided in the supporting member.

According to the invention, the recesses and the protrusions now have a noncircular cross-section, while a combination of a recess and a protrusion positioning a supporting pin in a particular position on the supporting member is located eccentrically in relation to the centreline of the relevant supporting pin.

The use of the eccentric location in relation to the centreline of a supporting pin of the combination of recess and protrusion positioning the supporting pin in a particular position in relation to the supporting member, renders it possible to place the supporting pin in different positions in relation to the centreline of this combination of recess and protrusion, whereby in the set position a rotation of the supporting pin about the centreline of the combination of recess and protrusion is prevented by the non-circular cross-section of the recess and the protrusion.

Preferably, the protrusions are rigidly attached to the supporting pin, and the recesses are provided in the supporting member, but it will alternatively be conceivable to provide the supporting member with protrusions, while the recesses are provided, for example, in a base or the like which is connected to the supporting pin.

The invention will be explained in more detail below with reference to the appended Figures.

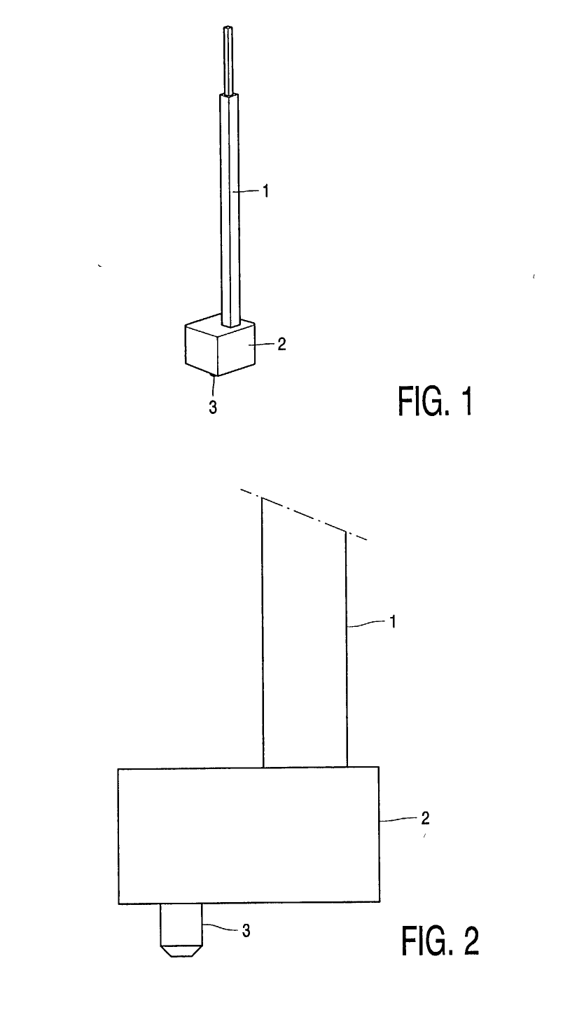

FIG. 1 is a diagrammatic perspective view of a supporting pin, the lower end of which is attached to a base.

FIG. 2 is a partial side elevation, on a larger scale, of the supporting pin with base shown in FIG. 1.

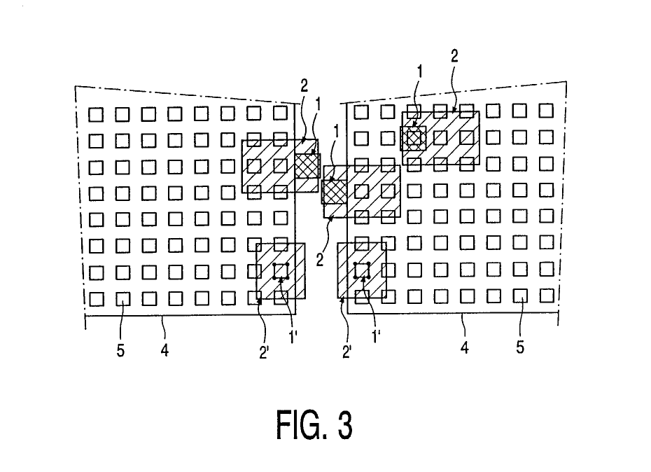

FIG. 3 is a diagrammatic plan view of two supporting members arranged next to each other with supporting pins placed thereon.

FIG. 1 shows a supporting pin 1, the lower end of which is attached to a base 2. A protrusion 3, which has a non-circular cross-section, square in the embodiment shown, is provided at the bottom of the base

A desired number of such supporting pins can be placed on a supporting member 4, often in the shape of a supporting plate, in which regularly spaced recesses 5 are provided in rows and columns.

As is also explained in cited publications, such supporting pins for supporting flat objects, in general printed circuit boards, are placed in a pattern on the supporting member 4 such that they only support the flat object concerned in certain intended locations at the bottom, in the case of printed circuit boards in those locations that do not contain circuit components.

Subsequently, the circuit boards thus supported are subjected to a desired operation, for example by feeding the circuit board thus supported through a machine intended for further operations.

As was explained above, the protrusions positioning the supporting pins in relation to the supporting member are located in line with the supporting pins in the known constructions. The consequence of this for the known supporting pins 1′ supported by bases 2′ is that a supporting pin 1′ is always located in line with the centreline of the recess 5 containing a protrusion connected to the supporting pin 1′, as is shown diagrammatically in FIG. 3.

As is also shown diagrammatically in FIG. 3, however, a positioning pin 1 placed on a base 2 can be arranged in different positions in relation to the centreline of the recess 5 in a supporting member 4 in which the protrusion 3 belonging to said supporting pin 1 has been inserted. It will be clear that, given a certain number of recesses 5 in a supporting member 4, the number of setting possibilities of supporting pins placed on a supporting member 4 has thus been considerably increased compared to the prior art.

Although it was indicated above that the protrusion 3 has a square cross-section and the recess 5 has a cross-section complementary to the former, it will be clear that also other non-circular cross-sections may be chosen for the protrusion 3 and the recess 5, for example rectangular, hexagonal, elliptical or the like, as long as it is ensured that the protrusion 3 can be inserted in at least two different orientations in a recess 5.

As was also stated above, it is alternatively possible to provide a recess in the base 2 such that this recess is located eccentrically in relation to the centreline of the supporting pin 1, while the supporting member 4 instead of having recesses 5 is provided with protrusions, which are complementary to the recess provided in base 2.

The base 2 should preferably be equipped with a magnet located near the bottom of the base, while the supporting member 4, at least at the top, is made of a magnetizable material. In this way, a strong bond between the base 2, carrying the supporting pin 1, and the supporting member 4 can be realized.

1. A device for supporting flat products, especially printed circuit boards, provided with a supporting member as well as supporting pins, which can be placed on and removed from the supporting member, wherein recesses and protrusions fitting in these recesses are provided for positioning the supporting pins in relation to the supporting member, characterized in that the recesses and the protrusion have a non-circular cross-section, while a combination of a recess and a protrusion positioning a supporting pin in a particular position on the supporting member is located eccentrically in relation to the centreline of the relevant supporting pin.

2. A device as claimed in claim 1, characterized in that the supporting pin is attached to a base which is provided with a protrusion on the side facing away from the supporting pin, while the supporting member is provided with a number of recesses.

3. A device as claimed in claim 1 or 2, characterized in that the protrusion has a polygonal cross-section.

4. A device as claimed in claim 1 or 2, characterized in that a magnet is connected to the lower end of the supporting pin, while at least the upper side of the supporting member is made of a magnetizable material.

5. A supporting pin designed in particular for a device as claimed in any one of the preceding claims, wherein a protrusion of non-circular cross-section, located eccentrically in relation to the centreline of the supporting pin, is connected to the lower end of the supporting pin.
